(19) United States
(12) Patent Application Publication
(10) Pub. No.: US 2011/0173300 A1
(43) Pub. Date: Jul. 14, 2011

(54) IPTV Presence And Interaction Protocol

(76) Inventors: Isaac Levy, New York, NY (US); Tal Shalom, Fair Lawn, NJ (US); Meir Sela, Cresskill, NJ (US); Stephan Wenger, Hillsborough, CA (US)

(21) Appl. No.: 12/943,622

(22) Filed: Nov. 10, 2010

Related U.S. Application Data
(60) Provisional application No. 61/264,466, filed on Nov. 25, 2009.

(51) Int. Cl. G06F 15/16

(52) U.S. Cl. 709/219

(57) ABSTRACT

Disclosed are techniques for a protocol that provides for a TV viewing experience with interaction by allowing for social collaboration of non co-located TV viewers and integrating the TV viewing experience with social networking concepts and interactive multimedia communication. The protocol enables a digital video distribution system (e.g., IPTV) to provide a user with presence, channel, and grouping information regarding other users in the IPTV system and available video content. The protocol also enables users of the IPTV system to interact using real-time and/or non-real time communication.

### CROSS-REFERENCE TO RELATED APPLICATIONS

This application claims the benefit of priority of U.S. Provisional Patent Application Ser. No. 61/264,466, filed Nov. 25, 2009, which is hereby incorporated by reference in its entirety.

### BACKGROUND OF THE INVENTION

1. Field of Technology

The disclosed invention relates to the integration of interactive multimedia communication between TV viewers in a TV system that are not co-located. More specifically, the invention relates to a protocol engine that enables use of bi-directional video-conference-like communication, integrated into an Internet-Protocol television (IPTV) setting.

2. Background Art

Subject matter related to the present application can be found in co-pending U.S. patent application Ser. No. 12/765,815, filed Apr. 22, 2010 and entitled “An Efficient Video Skimmer”; Ser. No. 12/765,793, filed Apr. 22, 2010 and entitled “Systems, Methods and Computer Readable Media for Instant Multi-Channel Video Content Browsing in Digital Video Distribution Systems”; and Ser. No. 12/765,767, filed Apr. 22, 2010 and entitled “Systems, Methods and Computer Readable Media for Instant Multi-Channel Video Content Browsing in Digital Video Distribution Systems”; as well as U.S. Pat. No. 7,593,032, issued Sep. 22, 2009 and entitled “System And Method For A Conference Server Architecture For Low Delay And Distributed Conferencing Applications.” All of the aforementioned related applications and patents are hereby incorporated by reference herein in their entireties.

IPTV is based on IP networks, which normally have bi-directional communication capability. However, the bi-directional communication capability, at present, is underutilized.

IPTV has been known for many years. Typical implementations utilize a client-server approach, wherein a server, under the control of an operator, provides the IPTV service. In the user premises, a computer (e.g., a set-top-box or a similar device or a general purpose personal computer) accesses the server and conveys the user's desire to view a certain channel. One protocol frequently used for this purpose is known as Real Time Streaming Protocol (RTSP, RFC 2326, available at http://www.rfc-editor.org/rfc/rfc2326.txt). The server reacts to requests by conveying the digital media, often in the form of Real-time Transport Protocol packet streams (RTP, RFC 3550, available at http://www.rfc-editor.org/rfc/rfc3550.txt) over IP multicast (RFC 3170, http://www.rfc-editor.org/rfc/rfc3170.txt). Other forms of client-sever communication and content distribution have also been disclosed (see for example co-pending U.S. Provisional Patent Application Ser. No. 61/172,355).

Traditional IPTV systems do not allow TV users to interact electronically. Such interaction is desirable, as it allows for a joint viewing experience of multiple users without requiring the users to be co-located.

“Chat” systems have been known for many years, often in the context of computer-based text chat. Some examples include Internet Relay Chat (IRC), and the proprietary forms of text chat deployed by many commercial providers, including MSN, Yahoo, and Google. Many modern text-chat systems allow augmenting the text-only chat session with a real-time, multimedia communication session that potentially includes text, audio, video, screen or application sharing, and sometimes other forms of electronic communication.

One aspect of chat systems is the concept of “presence.” In this context, “presence” means that a user receives information on other users who are logged into the system and available for human-to-human communication. Historically, presence was meant mostly as a means to determine whether a user is able to engage into a chat session, and a potentially chat-session-accepting user would have to set its desire (or lack of desire) to receive chat sessions explicitly. Today, though, presence information is often derived from various sources, including, for example, the user's computer-based calendar, or the user's recent activity on various presence-enabled devices.

As an IPTV or a presence system may potentially have billions of users, it is impractical to attempt to convey the presence state of each and every user to all other users. Further, most users value their privacy and are not interested in having their status known to everyone else. Therefore, modern presence systems contain forms of access management on both the initiating and the responding ends. For example, in many systems, a user can select to whom he/she wants to make his/her presence information available (at the initiating end). Further, the same user can also select other users in whose presence information he/she is interested in (at the responding end). In many systems, chat requests only go through if all users have all communicating users explicitly enabled at both the initiating and the receiving end. Common concepts for access management along these lines include, for example, “buddy lists,” i.e., lists of users acceptable to the initiation or receiving end, and no-call lists.

### SUMMARY

Disclosed are techniques for a protocol that provides for a TV viewing experience with interaction by allowing for social collaboration of non co-located TV viewers and integrating the TV viewing experience with social networking concepts and interactive multimedia communication, The protocol enables a digital video distribution system (e.g., IPTV) to provide a user with presence, channel, and grouping information regarding other users in the IPTV system and available video content. The protocol also enables users of the IPTV system to interact using real-time and/or non-real time communication.

In one embodiment, the present invention provides for a technique where a user can determine whether other users of the IPTV system are active on the system at any given time. In the same or another embodiment, the present invention provides information about available channels or semantic groups of channels. The user can filter the presence, channel, or grouping information, for example, based on users who watch the same channel or similar channels.

In the same or another embodiment, the protocol enables the IPTV system to address the user through real-time or non-real-time electronic communication, or allows interactive electronic communication between users. The protocol enables users to simultaneously watch a video channel while interacting in real-time with other users.

In the same or another embodiment, the IPTV system can include an access rights management system to limit the availability of presence information. The IPTV system can also utilize information available in existing social networks to enhance the TV viewing experience.

### BRIEF DESCRIPTION OF THE DRAWINGS

FIG. 1 is a block diagram illustrating a high-level architecture of an exemplary IPTV system in accordance with the present invention.

FIG. 2 is an exemplary endpoint in accordance with the present invention.

FIG. 3 is a block diagram illustrating exemplary users of an endpoint, and their representation in the production server, in accordance with the present invention.

FIG. 4 is a block diagram illustrating an exemplary media server in accordance with the present invention.

FIG. 5 is a flow diagram illustrating the operation of a media server (CSVS) in accordance with the present invention.

FIG. 6 is a block diagram illustrating a architecture of an exemplary production server in accordance with the present invention.

FIG. 7 is a database diagram of an exemplary database of the production server in accordance with the present invention.

FIG. 8 is an exemplary screen layout at an endpoint in accordance with the present invention.

FIG. 9 is a flow diagram illustrating the hierarchical group concept of the database of an exemplary production server in accordance with the present invention.

FIG. 10 is a block diagram illustrating an exemplary protocol implemented by the production server in accordance with the present invention.

Throughout the drawings, the same reference numerals and characters, unless otherwise stated, are used to denote like features, elements, components or portions of the illustrated embodiments. Moreover, while the disclosed invention will now be described in detail with reference to the figures, it is done so in connection with the illustrative embodiments.

### DETAILED DESCRIPTION OF THE INVENTION

The invention described herein enables, by the means of a protocol, a new rich TV viewing experience with interaction by allowing for social collaboration of non co-located TV viewers and integrating the TV viewing experience with social networking concepts and interactive multimedia communication. Specifically, the disclosed techniques allow for an IPTV system that conveys to the user various information. For example, the IPTV system can convey presence information (i.e., information regarding whether other users are active on the system at any given time) and can establish a presence state. As another example, the IPTV system can convey information about available video content, referred to as “channels”, including, for example, live/on-air, online or pre-stored video content, or information about semantically grouped channels, “groups” (for example, all news channels, all conservative news channels, all channels broadcasting a specific football game on a specific date, or all channels currently being watch by people on a user's chat system “buddy list”).

The IPTV system can filter this presence, channel, and grouping information along criteria such as, for example, users that are defined as “friends” or “buddies”, users that watch the same TV channel, users who watch “similar” channels (i.e., a different channel that is broadcasting the same or a different ballgame, as opposed to a news channel), as well as combinations of these criteria. For example, a user could select to receive information about “buddies who are currently watching the same ballgame as I am, regardless of channel,” or “buddies who plan to watch the same ballgame tomorrow as I plan to watch.” Filtering can happen both at the endpoint and at a centralized server, and can be based on user input (e.g., language, buddy list), TV operator based criteria (e.g., service level contracted), or objective criteria (e.g., time).

The IPTV system can utilize information available in existing social networks, for example, to update the presence state and/or the friends/buddy lists of the presence-enabled IPTV system, so as to enhance the TV viewing experience.

The IPTV system can address the selected users through any real-time or non-real-time electronic communication, including, for example, email, voice call, chat, or video call. When there is interactive communication between users, such as voice call, chat, or video call, the IPTV system synchronizes the interactive communication of all involved users with the TV channel.

The IPTV system can also include an access rights management system to preserve the privacy of users by blocking their presence information if they so desire.

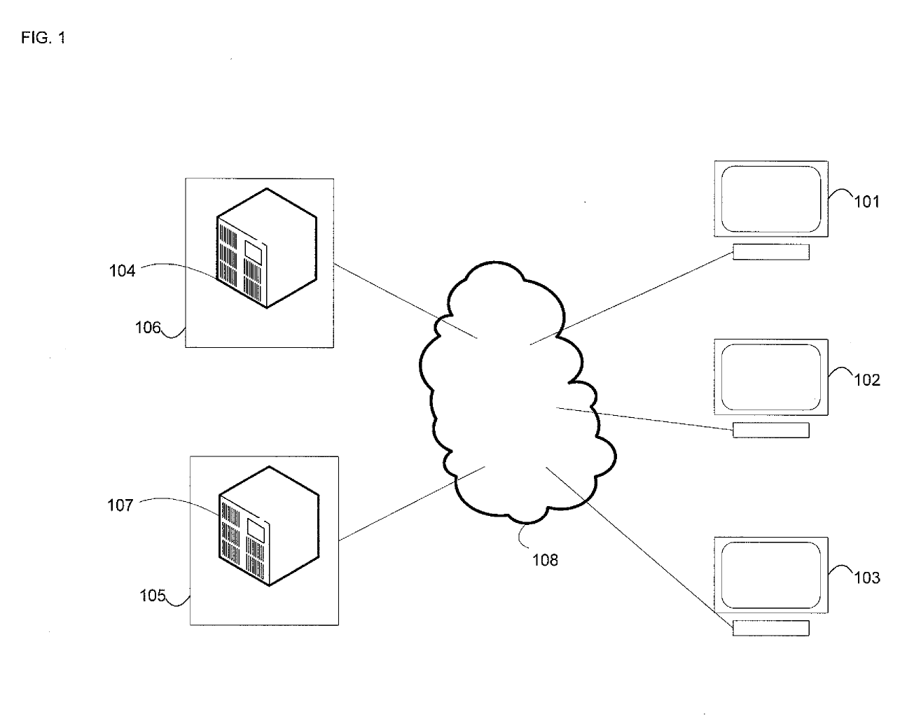

Referring to FIG. 1, the system consists of a plurality of endpoints (101, 102, 103), at least one media server (105), alternatively known as SVCS, and at least one production server (104), alternatively known as the application server. The media and production servers can be co-located on the same physical computer, and can also be distributed over multiple computers. For example, in FIG. 1, one production server (104) is run on one physical computer (106), and one media server (105) is run on a second physical computer (107). Endpoints (101, 102, 103) and servers (104, 105) are connected through a data network, which may be the public Internet (108) or any other public or private IP network. The media and production servers can be maintained and operated by a commercial IPTV service provider, henceforth referred to as an “operator.” However, an individual with the means and the interest in running a production and/or media server may act as an operator as well. Finally, media and production servers can be run by different operators.

The method is arranged so that endpoints, media server(s) and production server(s) achieve a desired behaviour, as discussed below.

The computer readable media comprises instructions to central processing units (CPUs), which are part of the endpoint, media server, and production server, respectively, arranged such that the method is implemented.

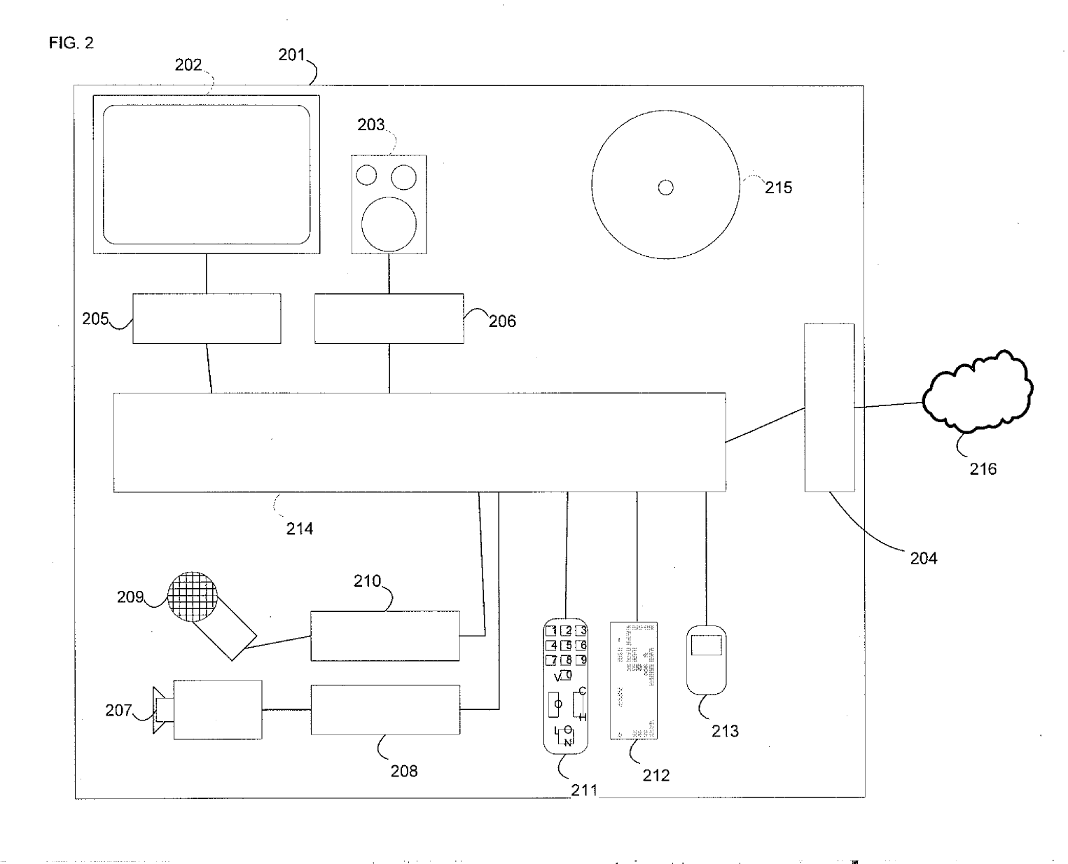

Referring to FIG. 2, an endpoint (201) includes peripherals such as a video display (202), for example, a TV or computer monitor, with a screen of sufficient size and resolution to allow watching a TV channel, and an audio output (203), for example, a set of loudspeakers. The endpoint (201) can further include, for example, a network interface (204) connected to a network, for example the Internet (216), one or more media decoders (205, 206) to process, for example, coded layered video and audio, connected to the video display (202) and audio output (203).

In the same or another embodiment, the endpoint can also include media input devices, such as a camera (207) connected to a video encoder (208), or a microphone (209) connected to an audio encoder (210). An endpoint can include user input devices, such as a keyboard (212), a mouse (213), or a TV-style remote control (211). The components of an endpoint are under the control of a control circuit (214) that can be programmable, and can include, for example, a CPU, Random Access Memory (RAM), Read-Only Memory (ROM), mass storage, and interfaces to the aforementioned peripherals. Some peripherals, can be integrated into the control circuit (214). For example, the decoder for layered video (205) can be implemented in software and run on the control circuit (214). The control circuit (214) can use software for its operation, which can be available on a computer readable media such as Flash ROM, ROM, CD ROM, DVD ROM, hard drive, or memory stick. In one implementation, all of the components, with the exception of the video display, audio output, media input devices and user input devices, can be integrated into a single physical device, such as a set-top-box or a personal computer.

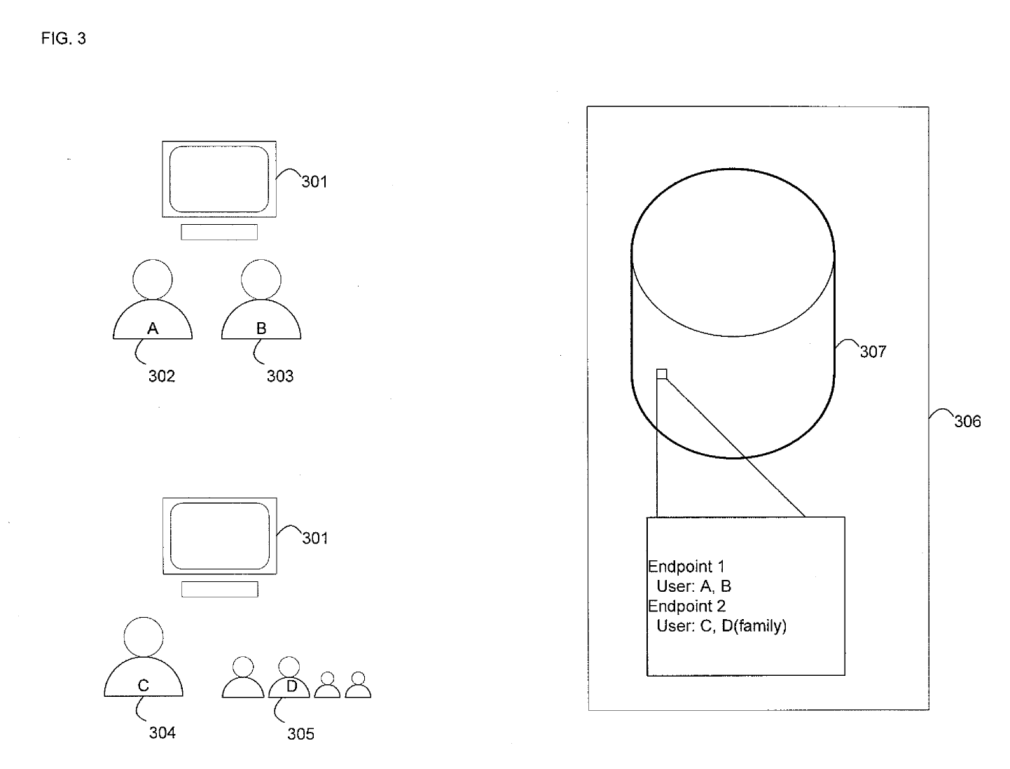

Referring to FIG. 3, each endpoint (301) at any given time has an associated set of active users (302, 303), which can be an empty set. A user is either a natural person (304), or a plurality of natural persons (305), for example, a family. Information about this set of active users is conveyed to the production server (306) and known there—it is part of the state of the production server and stored, for example, in a database (307). One way to convey this information is through a sign-in process that enables the advanced features of the system; however, other forms can be used. For example, an operator may choose to assume a fixed assignment of a user to an endpoint. This would emulate the access control common in today's cable TV (CATV) systems, where channels are enabled based on the physical location, and connectivity of the endpoint's computer or set-top-box, and/or on the presence of a “key” (for example, in the form of a SIMM card).

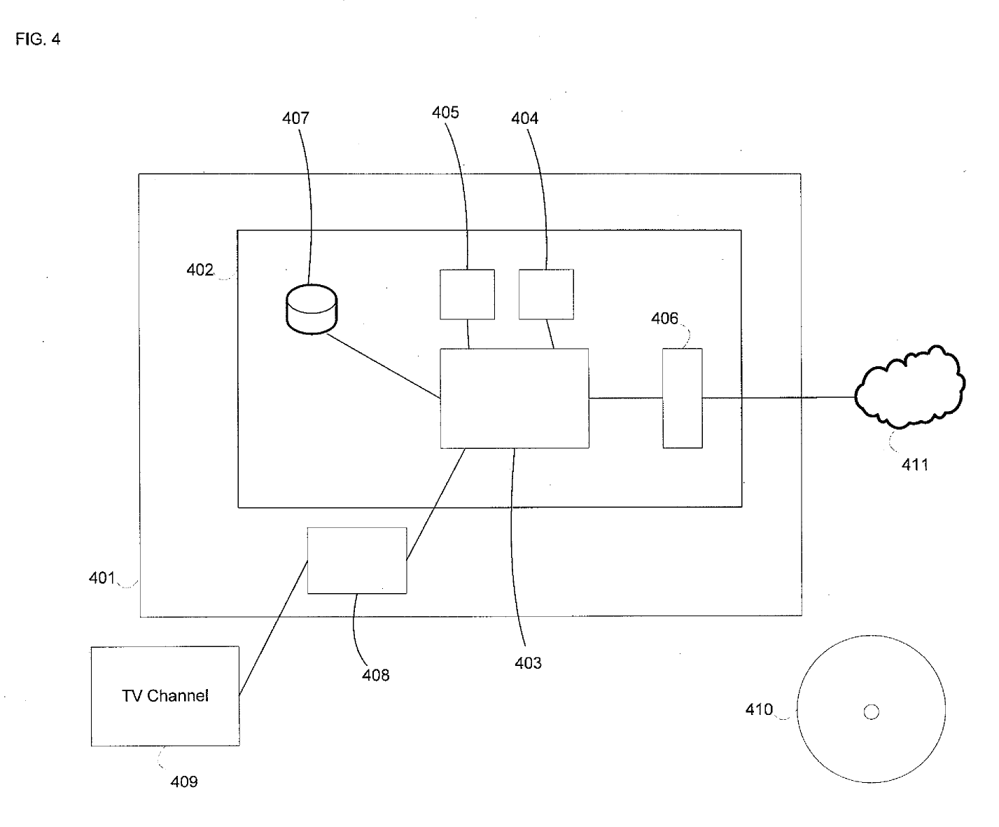

Referring to FIG. 4, the media server (401) can include a general purpose server computer (402) that includes elements commonly found in such server computers such as, for example, a CPU (403), RAM (404), ROM (405), one or more network interfaces (406) connected to one or more networks (411), for example, the Internet or other public or private networks, and one or more disk drives (407). The media server (401) can run under an operating system and can execute a server software package specifically designed to enable the media server functionality. However, specialized hardware architectures for the media server are also conceivable. For example, a media server (401) can include dedicated codec hardware (408) that converts, in real-time, TV channels (409) in their native analogue format or any digital format into the compressed digital format required by the IPTV system. Dedicated codec hardware can also be integrated in the computer (402) in the form of plug-in cards. The server software package can be stored and/or distributed on a computer readable physical medium (410) such as a CD-ROM, DVD-ROM, semiconductor-ROM, hard drive, or memory stick.

The media server's main purpose is, upon request from the production server and/or endpoint, as the case may be, to convey data packets comprising media from itself to one or more endpoints. The mechanisms and protocols supporting this process have been disclosed, for example, in U.S. Pat. No. 7,593,032.

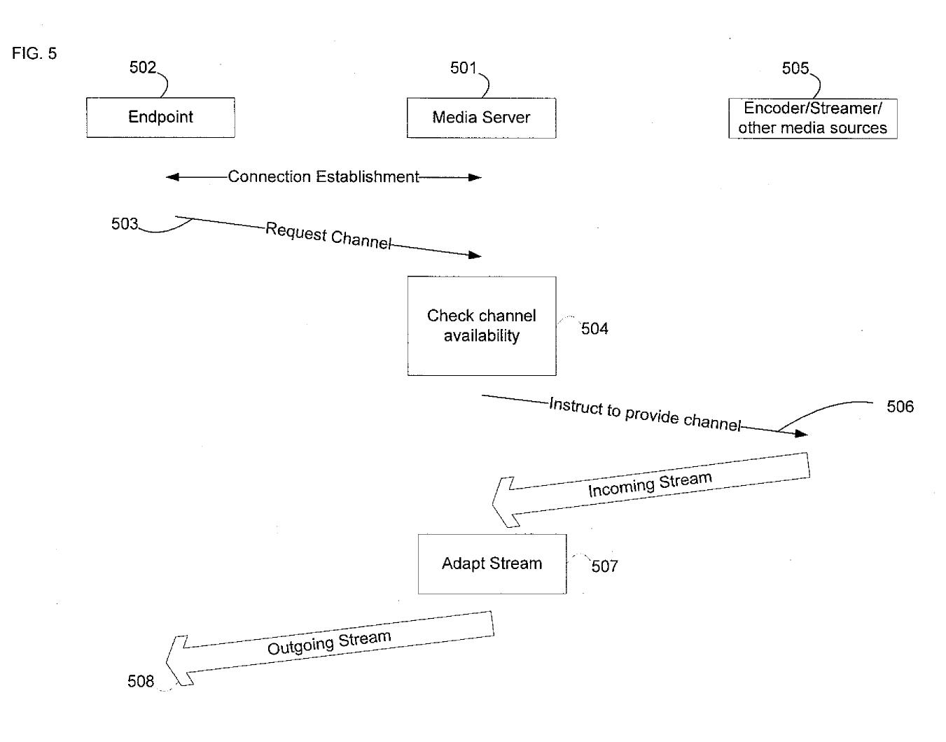

Referring to FIG. 5, much abbreviated, the media server's operation can be described as follows: once an endpoint (502) has established a communication with a media server (501), the media server waits for requests from the endpoint (502). The request (503) can be in the form that the endpoint requests to receive one or more channels. Once the media server (501) is informed that the endpoint (502) wishes to receive a certain channel, it checks (504) whether this channel is already available to it. If not, the media server (501) instructs (506) real-time encoders, streamers, or other media sources (505) as the case may be, to provide it with scalable coded media streams for the source. All aforementioned communication processes utilize a signalling protocol, which can be based on, for example, SIP (RFC 3261, available at http://tools.ietf.org/rfc/rfc3261.txt), RTSP (RFC 2326), or any other suitable standard or proprietary protocol. The incoming stream (507) received by the media server (501) in response to the request for scalable coded media streams (506) can be of a bitrate and/or complexity that can be higher than what the endpoint (502) is prepared to receive. The media server (501) forms the outgoing bitstream (508) in such a way so as to maximize the user's experience at the endpoint, which can include dropping one or more enhancement layers of scalable coded media to adapt (507) the bitstream to the endpoint's capabilities and/or the network capacity between endpoint and media server, adding error resilience information, handling Automated Repeat Requests (ARQ) so to repair critically important media streams that have observed, for example, a packet loss.

The production server can be implemented as a software package running on a general purpose server computer, similar to the media server disclosed above. Its hardware architecture can be similar to the one of the media server, as illustrated in FIG. 4. In contrast to the media server, however, the production server can omit codec hardware, because codecs are not necessary for its operation. However, the production server can include accelerators more suitable for its various purposes.

The purpose of the production server is manifold:

admission control of endpoints to the system,

maintaining the state of the presence engine; for example determining which users are logged in, or whether a given user prepared to receive messages, and

maintaining the state of the entire IPTV system, with the potential exception of those aspects of the state that are local to media server or endpoint(s) and, therefore, are advantageously maintained by the media server or endpoint(s), respectively.

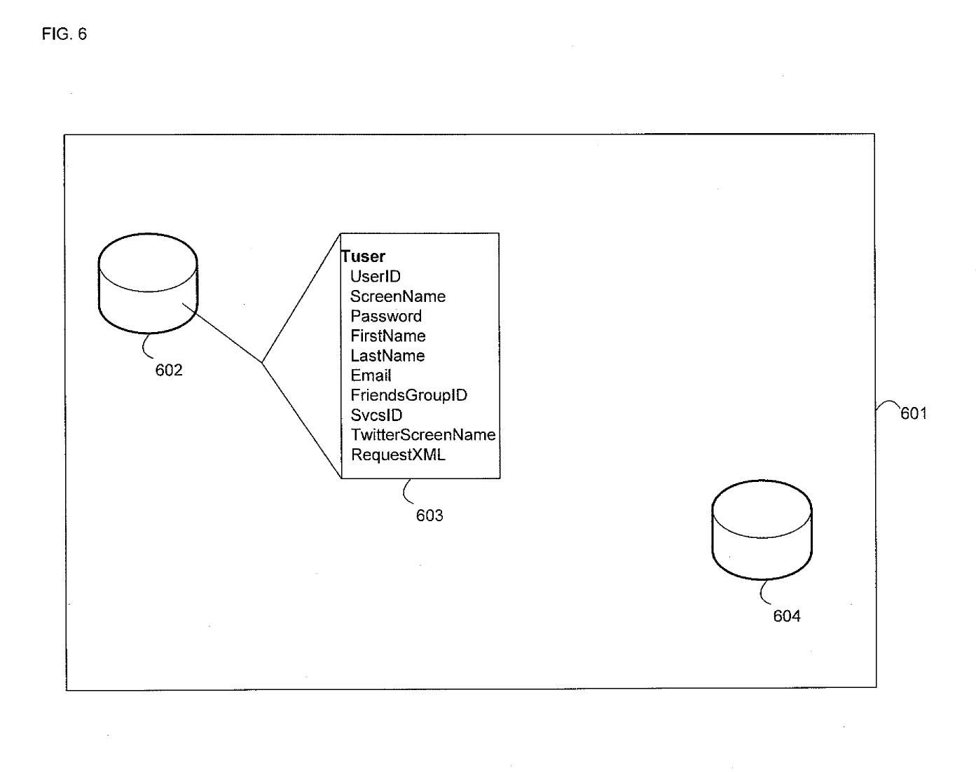

Referring to FIG. 6, the production server (601) has, at any given time, information on which channels are available to each endpoint and/or each user. This information is one element of a user database (602) that is part of the production server (601). One exemplary record (603) of the user database (602) is depicted, and will be referred to in more detail later. Availability information can be based on factors such as the service level contracted (for example, which premium channels have been contracted and paid for, settings of parental control mechanisms, access restrictions imposed by regulation, or active pay-per-view channels). The service level can be an attribute of the user or the endpoint. An endpoint-based organization of the user database (602) has the advantage of comparatively easy configuration for the operator, in-line with what is currently used in traditional CATV. The main disadvantage of endpoint-based organization the user database (602), and conversely, the main advantage of a user-based organization of the user database (602), is the lack of portability of user-contracted service levels between endpoints.

For example, if a user visits a friend's house, he/she is using the endpoint of the friend (and not his/her own), and, as a result, he/she is restricted to the service level of the friend (which may be lower than his/her own). Binding the service level to the user has the advantage of portability of the service between endpoints—a desirable feature that can be used to differentiate a modern IPTV service from a traditional CATV service. However, the user-based organization has the disadvantage of additional administrative requirements and efforts for the operator.

As another example, a user can maintain a “buddy” list of other users he/she is willing to share certain information with. The buddy list is user specific information and, therefore, is stored in the records of the user database (603). This information can be used, for example, so that only buddies are able to view the presence state of the user.

The production server (601) can also include devices to deal with other user or endpoint specific information. For example, a user can be able to upload content of his or her own to a location on the Internet or a media server, with access information (including, for example, from where to retrieve the information as well as access restrictions) being made available to the production server (601) in a content database (604). This enables the production server (601) to make that content available, in the form of a channel, according to the user's access restrictions.

The production server (601) has, at any given time, information on groups that are available to each endpoint. A group can include, for example, a subset of the channels available to the users of the endpoint. One example would be all football games a specific user is interested in (for example, the user may be a fan of a specific team and is only interested in games played by that team). However, groups can also be formed dynamically. For example, a group can be formed from all channels that are currently being viewed by any other user that is listed on the user's buddy list. Other forms of groups are also conceivable. In addition, groups can be nested into other groups. For example, there could be a group called “news channels” which contains groups called “Conservative”, “Liberal”, or “Centrist”.

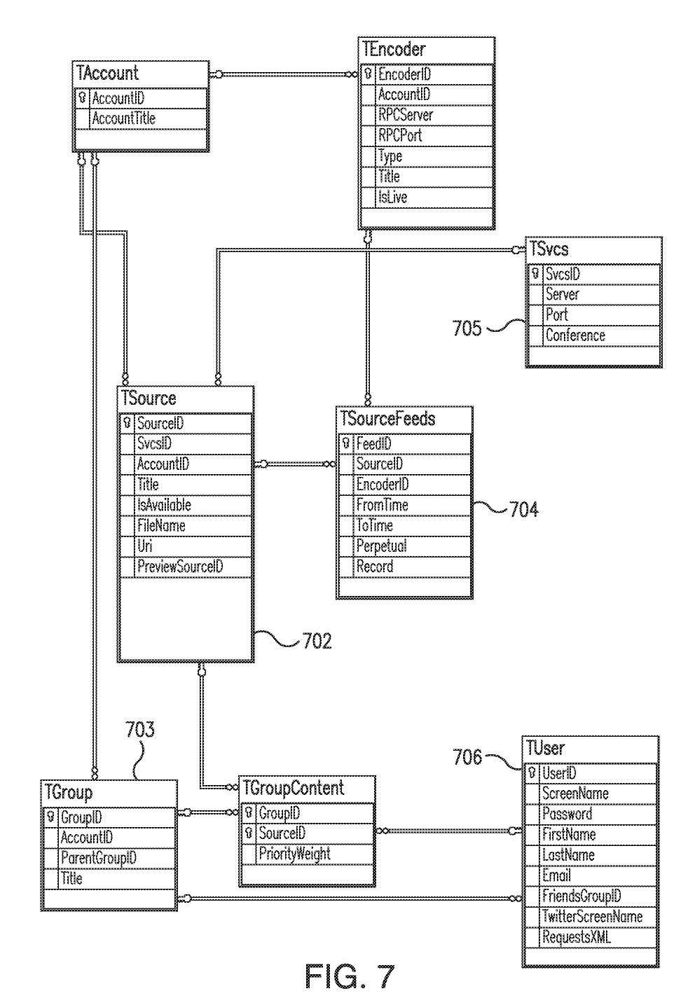

In one embodiment, the aforementioned databases and other state information are maintained in one database in the production server. The exemplary database diagram depicted in FIG. 7 includes the following tables:

Table of Sources, TSource (702) contains records including fields covering the basic access information for each source. A “source” is a descriptor for a multimedia data set. A source can be a descriptor for an IPTV channel that can be conveyed from the media server to the endpoint, a stored multimedia data (for example, an uploaded movie), or a real-time audio-visual communication channel, used to display the camera image from another endpoint in real-time. Fields can include, for example: SourceID (a unique descriptor used to access the source throughout the system), SvcsID (the media server that serves this source; see also TSVCS below), AccountID (the owner of the source, if any, which can be used for access rights management), Title (a human-readable representation of the content, for example, TV channel name such as “CNN” or “FoxNews”), IsAvailable (a flag indicating the source is available for serving at the time of the access to the database), Filename, URI (Unified Resource Identifier/Locator) (the location on the network for pre-recorded content), and PreviewSourceID (the SourceID of a mini browsing window (MBW) carrying the same content as the source).

Table of Groups, TGroups (703) can contain records including group-related fields, such as, for example, GroupID (a unique descriptor used to access the group throughout the system), AccountID (the owner of the group), ParentGroupID, and Title (a human-readable representation of the group's content, for example “News Channels”, “Conservative News Channels”, “Sports Channels”). A group is a structure including groups and sources, among other information. A reasonable equivalent for a group is a directory in a hierarchical file system. Such a directory can contain other directories (equivalent to other groups), data files (equivalent to sources), and other information (for example a thumbnail database). The GroupID identifies a group. The ParentGroupID identifies the parent group, in which the group in question is a member.

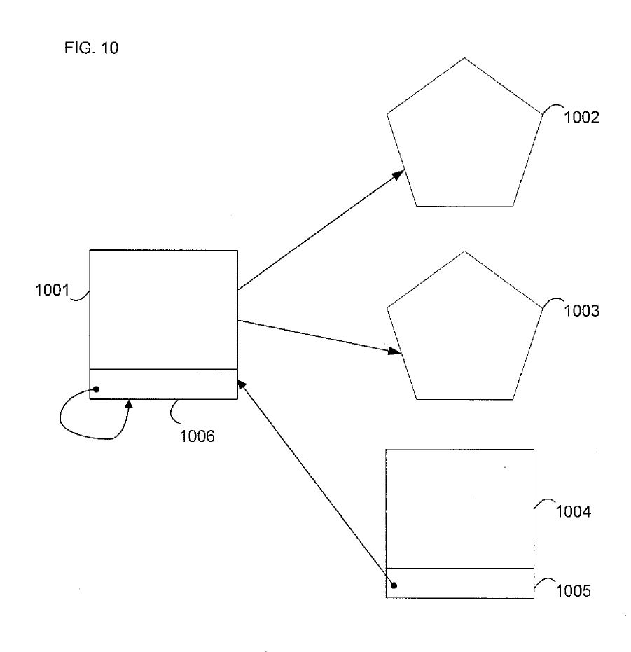

Referring to FIG. 10, a first group (1001) includes sources (1002) and (1003), as well as a second group 1004. Within the second group (1004), the ParentGroupID field (1005) identifies the first group (1001). The ParentGroupID field of the highest group in a hierarchy (1006) can point to the highest group itself.

Table of Source Feeds, TSourceFeeds (704), returning to FIG. 7, contains records including information utilized to control the media server. Records of this table are accessed through SourceID, and include, for example, EncoderID (a unique descriptor used to reference the TEncoder table (707), see below), FromTime and ToTime (indicating the timeframe in which the source is active, which is relevant, for example, for a life channel that has only certain hours of activity), Record (a flag indicating that the source feed is to be recorded locally for future reference), and Perpetual (a flag indicating that the source is always active).

Table of media servers, TSvcs (705) is accessed through SvcsID, and contains records including, for example, the network location of the media server: Server (IP address of the server), Port (port number of the server), as well as Conference (a unique descriptor referencing a virtual communication relationship between endpoints and other SVCSs).

Table of users, TUser (706) is accessed through UserID, and contains records including, for example, ScreenName (a human readable nickname of the user, displayed in the user interface), Password, FirstName and LastName, Email, FriendsGroupID (a group including records of the sources of all users which the user has configured as being his/her friends), SvcsID (the default media server for this user), TwitterScreenName (the user ID of the user in the social networking site Twitter, listed here as one example of a social networking site), and RequestsXML (an XML representation of pending requests and/or recommendations concerning this user, see below under “reportRequestsAndStatuses”).

Pursuant to U.S. privacy laws, users have the right to keep some of their personal data private, such as, for example, viewing preferences, buddies lists, and real-time presence information. The production server can maintain a database with access rights, which includes information for each user regarding the extent to which the user is willing to share personal data with other users. Other users can be a defined subset of the whole user population. In a public IPTV setting, for example, a user can allow those on his/her buddy list to receive the user's real-time presence information (if they choose to do so), except when the user is viewing channels he/she explicitly marks as private. In another example, if IPTV system were deployed as part of a campus network to support remote teaching, a student user's presence information could be always accessible to the faculty, especially in a case where the campus network allows only for professional use. To support both examples, the IPTV system can include mechanisms through which a user, through a user interface at an endpoint, or other means, can establish, update, query, and remove access rights. Similarly, the network operator can update, query, or remove those rights as well.

In an exemplary embodiment of the invention, all information related to channels, groups, users, endpoints, and access rights are stored in a database accessible by the production server. The production server offers access to parts of this database through a number of XML services to an authenticated endpoint. Typically, a web-based application running on the endpoint computer, e.g., a set-top-box, makes use of these XML services to obtain information from the production server, for internal processing and, in the end, displaying to the user through a user interface. A person skilled in the art will understand that many other forms of communication between production server and endpoint, as well as many other uses of those services, can also be utilized.

In order to properly disclose the use of the aforementioned database elements and their interworking with the XML services described later, it appears helpful to provide a brief overview of one exemplary user interface that can be utilized by using the XML services and the database information available in the production server.

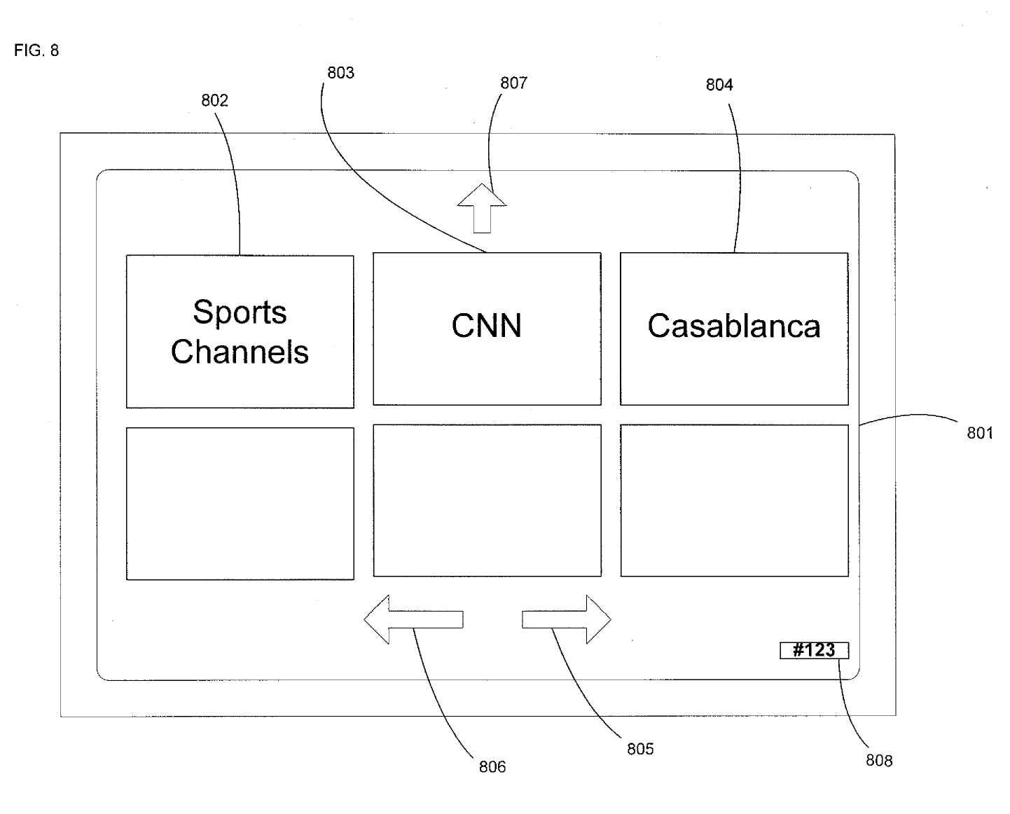

Referring to FIG. 8, the operation of one exemplary user interface is described. After the system has started and the user has authenticated himself/herself to the system, the endpoint video display (801) can show an initial screen wherein six mini browsing windows (MBWs) (802, 803, 804) show available video content or available groups. One MBW (802) can show a group denoted “sports channels,” a second MBW (803) can show a live/on-air TV channel called “CNN,” and a third MBW (804) can show an available on-demand movie called “Casablanca.” The other three MBWs can be empty.

The user can use an input device (e.g., a remote control, computer mouse, or keyboard) to select video content by pointing and clicking on any of the MBWs. Clicking on an empty MBW has no effect.

Clicking on the MBW “sports channels” (802) can, for example, open a new page with four national sports channels in four MBWs, a group called “local sport channels” in a fifth MBW, and a group called “recorded sports events” in a sixth MBW. The user can access additional sports channels through the hierarchical system (i.e., by clicking on the MBW representing the group “local sport channels”), or by using the “left” (806) and “right” (805) arrows as discussed below. If, when browsing the sport channels, the user clicks on the “up” arrow (807), the system can show again the initial screen.

Operator or user can configure more than six MBWs, by associating an MBW with content. These additional MBWs are access by clicking the “left” (806) or “right” arrows (805), which replaces the six currently visible MBWs with six other MBWs, creating a paginated layout wherein six MBWs form a page.

The user can click on the MBW “CNN” to switch the system into full-screen mode, wherein the whole screen area is used for a single channel, namely CNN. If the user, for example, presses a “menu” button on his/her remote control, the system can return to browsing mode.

Clicking on the MBW “Casablanca” can have a similar effect as clicking on “CNN”, except that a) the system could check whether the user is authorized to watch the movie “Casablanca” (aspects such as, for example, parental control, service level of the user, or status of the pay-per-view for this movie, can be of relevance for this decision). If, for example, the user is authorized to watch the movie, then the system can start playing “Casablanca”; If not, many different reactions are conceivable g, e.g., displaying an error message, offering a purchase of the movie, or fall-back to the menu screen.

In the following, a few of the XML services shall be introduced; many other services can be devised. As for the notation, a descriptive syntax commonly known from Microsoft's net framework is used here. While this notation is used herein for consistency, a person skilled in the art should readily understand that other notations could also be used to describe the invention.

getSourcesFromGroup.aspx?GroupID=[guid]&page=[number]&guid=[user's guid]: This XML service returns a list of source IDs available to this group, by the page number. FIG. 8 depicts an exemplary screen layout of an endpoint-based application making use of this service. The page number (808) relates to the page of source offerings in the user interface on the endpoint. In one exemplary embodiment, the number of sources per pages is fixed to, for example, six sources, and the up to six sources are displayed in MBWs (802, 803, 804). In this embodiment, a call of getSourcesFromGroup with page number 1 returns, among other information, the source ID of the first six sources the user has access to, page number 2 returns the second six sources, and so forth. In another embodiment, a different layout can be used for each page. Since the production server is aware of the layout information, it can easily calculate which sources are allocated to each page. The numerical ordering of the source IDs in the numbering space that is used to determine which source ID belongs to which page can be implemented in many ways. One simple form of numerical ordering would be to assign each TV channel the number it has assigned in the CATV service. Other numbering schemes can be employed. The user can browse through pages by pressing the left and right buttons (805, 806).

getAllSourcesForGroup?groupID=[guid]: This XML service returns a list of source IDs for a given group, equivalent to getSourcesFromGroup without the pagination described above. As the amount of information is probably quite large, it is unlikely that this service can be used directly by a user interface; however, it can be useful for caching of database information in the endpoint or similar reasons.

Each of the following XML services returns one or more user's preferences:

getUserPreferences.aspx?guid=[ ] or getUserPreferences.aspx?screenName=[ ]&password=[ ]

createUserPreferences.aspx?guid=[guid]&screenName=[ ]&password=[ ]&firstName=[ ]&lastName=[ ]&email=[ ]&twitter=[ ]

updateUserPreferences. aspx? guid=[guild]&screenName=[ ]&password=[ ]&firstName

reportRequestsAndStatuses.aspx: This XML service triggers the sending of an XML message via POST from the production server to the endpoint at which the user is logged in. The message can include information such as the channel(s) the user is currently watching, any invites or recommendation he sends to other users, and similar information.

An “invite” represents a request by another user; typically a friend, to join him/her to watch a certain source (typically a TV channel or a stored multimedia session) together. Watching “together” means that the users have an interactive multimedia communication relationship—for example, a video conference session—running in parallel with the IPTV channel or reproduced multimedia session. The video display at an endpoint can display, for example, a MBW displaying a user who is watching the channel “together” in addition to the main TV channel itself Similarly, the audio channels of the respective MBWs and the main TV channel are mixed. The result is a TV watching experience similar to having the people who watch “together” in the same room.

A “recommendation” represents an indication that a user recommends watching a certain source (e.g., a specific TV channel) at a certain time.

While an “invite” implies that the inviting user is (or will be, as the case may be) also online and available for viewing the source “together”, a “recommendation” does not imply this.

searchFriend.aspx?searchString=[ ]: This service returns the users that match the filtering search string. In one exemplary embodiment, the production server checks whether it finds the filtering string included in any of the fields of the user preferences (such as, for example, first and last name, screen name). In the same or another embodiment, more complex matching algorithms can be employed. For example, the search string can contain a regular expression, or the combination of a required field name (of the field names in the user preferences) and a regular expression, such as, for example, “LastName=*man”. This search string would match users with the last name of “Freeman” and “Guzman”, but not users with a last name of “Miller” or “Jones”. Other forms of matching algorithms can be used.

addFriend.aspx?friendSGroup=[guid]&newFriend=[guid]: This service returns a new list of friends, which includes the newly added friend(s). As a side effect, addFriend includes the User ID of the new friend(s) into the user information in the production server's database.

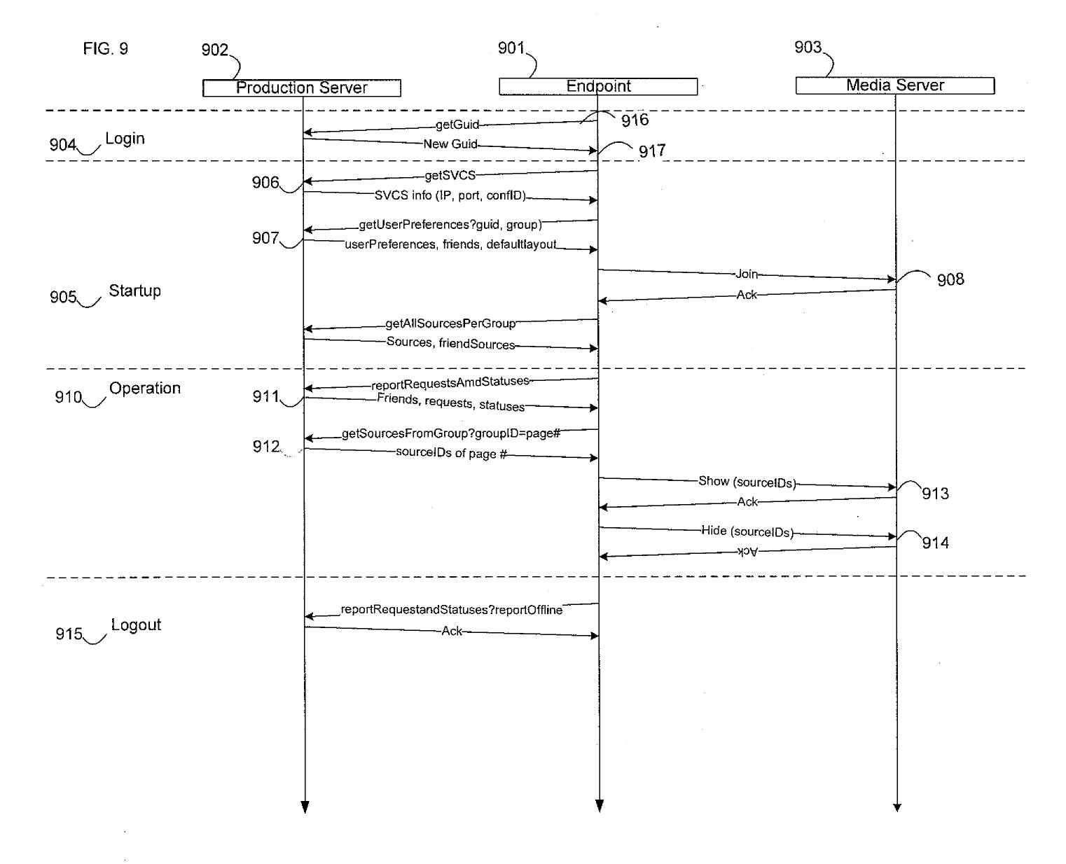

Referring to FIG. 9, in one embodiment, the production server (902) implements the following application logic and protocol between itself and the endpoint (901). FIG. 9 also depicts aspects of the protocol interchange between endpoint (901) and media server (903).

Part 1: Login Process (904)

After the initial IP connection establishment (for example, Point-to-Point Protocol over Ethernet (PPPoE) negotiation or similar mechanisms), if necessary, and initial authorization of the user(s) currently having access to the endpoint, the endpoint requests (916) from the production server a new User ID. The initial authorization can, for example, include a username password exchange, the check of access chip card credentials, or other suitable technologies. It is envisioned that the authorization process, in most cases, is lightweight; a CATV-based TV gets authorized without much user activity except pressing the “On” button on the remote control, and users may prefer a similar experience. However, such an experience can be facilitated even in conjunction with a secure login process through the means of cookies or other mechanisms. The authorization credentials can be local to the system or can be based on one of the established or emerging Web-wide authorization techniques.

The production server answers (917) this request by providing a new, unique user ID (GUID) to the endpoint. This User ID is henceforth be used to indentify the user (or the group of users) having access to the endpoint from which the request has been sent.

Part 2: Startup Process (905)

Immediately following the login process, a startup process commences. The main purpose of the startup process, from a user's viewpoint, is to present the user with an initial screen of the user interface.

Part 2.1: Establish the Media Server (906)

The endpoint sends a getSVCS message to the production server, thereby requesting information related to the media server's access. The production server fetches the appropriate record from the Table of SVCS in the database, by indexing this table through a key available in the user's database record. The production server replies to the endpoint with a message that can provide information such as the network address (IP address and port number) of the media server, as well as the session identification (conference ID) and other data. In one exemplary embodiment, there is only a single Media Server, and the production server returns the single entry in the tables of SVCs. In another exemplary embodiment, though, a single media server is not able to serve the demands of all deployed endpoints, and accordingly, the system contains more than one media server. The production server is aware of the network topology, the location of the endpoint (based on the user(s) logged into that endpoint) both with request to the topology and geographically, the load of each media server and possibly other factors. According to none, some, or all of the factors mentioned, the production server selects one media server to henceforth serve this endpoint, and conveys information about the endpoint, including, for example, its IP address, port number, or conference ID. The selection process can be implemented, for example, using an algorithm to identify the media server with the fewest “hops” between the media server and the endpoint (“hops” being direct connections between IP routers required to send an IP packet between the endpoint and the media server). If there is more than one media server with the same number of hops to the endpoint, and the production server can select between those randomly. Many other, possibly much more sophisticated, algorithms can be used to implement this selection process, including algorithms that, for example, bear some similarity with load balancing algorithms commonly used to balance the load of multiple web servers handling requests for the same web page.

Part 2.2: Establish User Preferences (907)

The endpoint sends a getUserPreferences request message to the production server, indicating the user(s) of the endpoint by referencing the GUID established in Part 1. The production server replies with at least one message containing information including, for example:

user preferences associated with each user, such as, for example, the user's first and last name, social networking access credentials (e.g., Twitter Name), access rights (as discussed above under Tusers),

presence information of the user's friends (by correlating the user's friends list as stored in the production server), their login status (as known from their login (904)), and their access rights, or

the default layout for this endpoint, as computed by the production server based on the default layouts associated with each user at the endpoint and/or other factors.

In an exemplary embodiment, the computing process can be implemented using the user's default layout if there is only one user at the endpoint, and the use of a fixed, operator selected layout if there is more than one user at this endpoint. In the same or another embodiment, the computing process can be implemented by creating a new layout based on aspects common to each associated user's layout. For example, if there are two users, the first having a default layout consisting of one main window and four MBWs located to the right of the main window, and a second user's default layout consisting of one main window and six MBWs located at the right side of the main window, the production server can display one main windows and five MBWs. Further, if one user's default layout requests a first channel to be displayed in the main window, and the second user's default layout requests a second channel, the production server can randomly select between the two channels.

Part 2.3 Establish Connection with Media Server (908)

The endpoint sends a “join” request to establish a connection with the media server. The media server sets up a state for the new endpoint to be served, allocates resources, and acknowledges the join request.

Part 2.4 Fetch Information About the Sources (909)

The endpoint sends a request to the production server to provide all sources currently known to be relevant for the user. The response by production server can include, for example, the source information of all friends in any of the user's friends lists, as well as a source for the endpoint's own camera image (to allow the display of loopback), sources for all the channels of the default layout, as established during the startup (907), as well as other information.

Part 3: Operation (910)

Part 3.1 Report Requests and Statuses (911)

In regular intervals, for example, every two seconds, the endpoint sends to the production server a request to send back the statuses of all friends, as well as any requests related to these friends. The production server replies with the requested information. Part 3.1 is executed independently from the other sub-parts of the operation (910).

The statuses of a friend comprises the presence information. Implicitly, by including a friend's user ID, that friend is present. Additionally, the “type” of presence can be included, for example, “viewing”, “away from TV”, “do not disturb”. Further, the statuses can contain other data, including, for example, information pertaining to the sources the friend is currently watching.

The requests related to a friend include invites and recommendations as outlined in reportRequestsAndStatuses above.

Part 3.2: Get a Page of Paginated Sources for a Given Group ID (912)

The endpoint sends a getSourcesFromGroup request with a given page number and a given Group ID. When this request is made for the first time after the startup phase, the page number is set to 1 and the group ID is the highest group in the hierarchy of groups to which this user has access. Later, the user, through the endpoint's user interface, has the option to select page numbers of the same group, for example by moving “up” or “down” one page, or by directly accessing a page with a certain number. The user can further browse through the subgroups of the first group. Note that a “page” can consist entirely of MBWs, entirely of a full screen source, or a combination thereof

The production server responds with the sources of the selected page.

Part 3.3: Show (913)

The endpoint requests the media server to display the media descript by the sources obtained (912) from the production server. The media server acknowledges this request and, from that point in time onwards, conveys media packets representing the media data descript by the sources. At this point, endpoint displays one or more active video channels on the user interface.

Part 3.4: Hide (914)

Once the user, though the user interface, has requested to change the viewing experience (for example by using the up/down buttons on the TV remote control to change the channel, or using the menu button on the TV remote control to return to the paginated source view to select another channel), the endpoint sends a “hide” request for the affected sources to the media server. The media server acknowledges the request and stops conveying media packets representing the media stream in question.

Part 4: Logout (915)

Once the user stops watching TV, the production server and the media server are informed about this situation by either one of two different mechanisms. The first is an explicit logoff, sent from the endpoint to production and media server. Once a logoff request is received, the production and media servers acknowledge the receipt, and tear down their respective activities related to this endpoint.

The second option is a timeout mechanism. Between endpoint and production server there is the regular activity of the reportRequestsandStatuses during regular operation (911). If the production server stops receiving such requests for an extended period of time, for example, thirty (30) seconds, it can assume that the endpoint has been switched off, lost connectivity, or has been exposed to another failure condition. Accordingly, the production server acts as if it has received a logoff request. A similar mechanism is run between the endpoint and the media server through the protocols that convey the media packets, namely RTP and RTCP.

Integration with established social networking services is also desirable. As one prominent example, the integration to Twitter shall be described. However, the present invention envisions that the IPTV system can be integrated with other social networking services.

Twitter is, at the time of disclosure, one of the most successful commercial social networking web sites. In brief, it offers a user with web access to create a user accounts, which allows him or her, after having signed in, to a) create short commentaries, known as “tweets” on any subject allowed by the site, and b) read the tweets created by the user or any other user. As there are now many million users on Twitter, the site further allows each user to create a list of other users whose tweets are of interest to the user, wherein a user has one or more “followers” and can “follow” the tweets of one or more other users.

Other social networking sites can have similar concepts that associate one user with a set of other users. For example, the social networking site “Facebook” allows to create “Friends” lists.

“Friends” lists, “Follower” lists, and similar lists in social networking sites have a lot in common with the friends lists of a presence service and of the disclosed invention. One key difference is, though, that the social networking sites are typically not conveying presence information and, therefore, the emotional hurdle for a user to sign up with such a service is somewhat lower. Further, Twitter, as well as other social networking sites, at the time of disclosure, enjoy a high popularity. As a result, a system that integrates with the wealth of information Twitter (and/or other social networking sites) provides, may well enjoy a high popularity amongst the most critical user bases. It is therefore of advantage that the disclosed system can interface with Twitter and/or other social networking sites.

In one exemplary embodiment, the disclosed system stores the account credentials necessary to access the Twitter web site in the records of the Table of Users. During the Startup phase, the production server accesses the Twitter web site through Twitter's API, utilizing the account credentials stored in a first user's record in TUsers. The Twitter web site provides a list of those users that follow the first user's tweets (i.e., a “followers list”), as well as a list of those users that are followed by the first user (i.e., a “following list”). The production server can, by correlating the Twitter user names with other Twitter user names stored in its database, correlate either or both of the two lists, and create a “friends” list in its own user name namespace based on the information retrieved. This friends list can henceforth be used as any other friends list.

The aforementioned interaction between Twitter (or other social networking site) and the system has a number of advantages for the user. First, the user does not need to actively maintain “friends” lists in two different systems; the user can maintain one such list in the form of the following list. Second, by using the following list as a friends list, a user can establish richer forms of communication with people who follow the user compared to the form of communication that Twitter offers.

Twitter specifically allows access to the data required for the aforementioned embodiment. However, the access restrictions implemented in Twitter are meant for the comparatively minimal means of communication available in Twitter. In contrast, the disclosed system allows very rich forms of communication. Therefore, the system will likely require a mechanism that allows each user to select whether to allow other users to access his/her TUsers record through his/her Twitter user credentials (or credentials of another social networking site). Further, it is sensible to also differentiate between the two access lists Twitter provides. The user names on the followers list are established by the following users, based on their decision. This is in contrast to the following list, which is established by the user himself/herself, without the users on the list necessarily consenting to being on the list.

We claim:

1. A system comprising:
(a) a production server
(b) a media server, and
(c) at least one endpoint,
wherein the production server is configured to provide the endpoint with a plurality of sources, the endpoint is configured to receive and select at least one of the sources, and the media server is configured to provide the endpoint with at least one media associated with the source IDs of the at least one source selected by the endpoint.

2. The system of claim 1 wherein the at least one endpoint authenticates itself with the at least one production server.

3. The system of claim 1 wherein the endpoint receives, from the at least one production server, SVCS info.

4. The system of claim 1 wherein the endpoint receives, from the at least one production server, a user preference.

5. The system of claim 1 wherein the at least one endpoint receives, from the at least one production server, at least one of a friends list, a requests list, and a status list.

6. The system of claim 3, wherein the at least one endpoint requests, from the at least one media server, based on the SVCS info, at least one session join, source show, and source hide.

7. The system of claim 5, wherein the status list includes presence information.

8. The system of claim 6, wherein the source may be associated with at least one of a live TV channel, a on demand movie, a live picture captured by a camera of another endpoint, or a group.

9. The system of claim 6, wherein a media associated with a source ID, itself associated with a source, is displayed in at least one of a MBW or a full screen.

10. A method for communicating between at least one production server, at least one media server, and at least one endpoint, comprising:
a) authenticating the at least one endpoint with the at least one production server;
b) the at least one endpoint receiving, from the at least one production server, SVCS info;
c) the at least one endpoint joining the at least one media server based on the SVCS info;
d) the at least one endpoint receiving at least one source ID from the production server;
e) the endpoint requesting at least one source ID from the media server; and
f) the media server sending media associated with the at least one source ID to the at least one endpoint.

11. The method of claim 10 further including steps of:
(a) the at least one endpoint requesting at least one user preference; and
(b) the at least one production server sending at least one user preference.

12. The method of claim 10 further including steps of:
the at least one endpoint requesting at least one of AllSourcesPerGroup, SourcesFromGroup; and
the at least one production server sending at least one SourceID.

13. The method of claim 10 further comprising:
(a) the at least one endpoint requesting from the at least one production server at least one of requests and statuses, and;
(b) the at least one production server sending to the at least one endpoint at least one of requests and statuses.

14. The method of claim 10 further comprising:
(a) the at least one endpoint sending to the at least one production server a report indicating that it is going offline;
(b) the at least one production server logging out the at least one endpoint

15. The method of claim 10 further comprising:
(a) the at least one production server logging out the at least one endpoint in response to a timeout.
